(19) United States
(12) Patent Application Publication
(10) Pub. No.: US 2018/0234437 A1
(43) Pub. Date: Aug. 16, 2018

(54) CYBERSECURE ENDPOINT SYSTEM FOR A NETWORK

(71) Applicant: GENERAL DYNAMICS MISSION SYSTEMS, INC., FAIRFAX, VA (US)

(72) Inventors: Sean McGaughey, FAIRFAX, VA (US); John Morgan, FAIRFAX, VA (US)

(21) Appl. No.: 15/897,285

(22) Filed: Feb. 15, 2018

Related U.S. Application Data
(60) Provisional application No. 62/459,110, filed on Feb. 15, 2017.

(51) Int. Cl. H04L 29/06

(52) U.S. Cl. CPC H04L 63/1416; H04L 63/1425; H04L 63/166; H04L 63/0428

(57) ABSTRACT

The disclosed embodiments relate to a cybersecure endpoint (CSE) device for a communication system. The CSE device performs a computer-implemented method for protecting an unsecure device coupled to a secure network from an electronic communication containing malware or malicious code. To do this, the cyber secure endpoint device receives a Transmission Control Protocol/Internet Protocol (TCP/IP) communication from a TCP/IP network and performs cybersecurity analysis on the TCP/IP communication to detect the malware or malicious code. When the malware or malicious codes is not detected, a protocol transformation is performed on the TCP/IP communication to create a downstream communication, which is transmitted the downstream communication to the unsecure device via a non-IP addressable communication channel.

### RELATED APPLICATION

This application claims the benefit of U.S. Provisional Application No. 62/459,110 filed Feb. 15, 2017.

### TECHNICAL FIELD

Embodiments of the present invention generally relate to cyber-security for a Transmission Control Protocol/Internet Protocol (TCP/IP) network, and more particularly relates to a cyber-secure endpoint device providing cyber-security protection for unsecure downstream equipment.

### BACKGROUND OF THE INVENTION

In May, 2016, the Department Homeland Security (DHS) Office of Inspector General (OIG) issued a report of an audit conducted by DHS OIG concerning information technology management of the Transportation Security Agency (TSA). Generally, the root report concludes that the TSA did not effectively manage its information technology components of the TSA's Security Technology Integrated Program (STIP). The report made several recommendations resulting in the TSA issuing nine requirements for Transportation Security Equipment (TSE) equipment that must be complied with for any TSE to be connected to the TSEs network. As a result, all TSE sensors had to be disconnected from the TSA network for failing to comply with the nine requirements. The disconnected TSE sensors included passenger imaging sensors, baggage x-ray sensors, explosive trace detectors, explosive detection systems and credential authentication technology. With these TSE sensors disconnected from the TSA network, data and images collected from the sensors cannot be readily provided TSA agents or officials, and updates or parameter modifications cannot be sent to the TSE sensors directly via network but must be done manually. For the thousands of disconnected TSE sensors this represents an expensive and time-consuming task.

Accordingly, there is a need for a system and method that permits existing TSA sensors to be reconnected to the TSA network in a secure manner. It would further be desirable for such a system and method to resist cyber attacks and comply with all nine requirements of the TSA for cybersecurity. Furthermore, other desirable features and characteristics of the present invention will become apparent from the subsequent detailed description taken in conjunction with the accompanying drawings and the foregoing technical field and background.

### SUMMARY

The disclosed embodiments relate to cybersecure endpoint device for a communication system.

In a first non-limiting embodiment, the cybersecure endpoint device performs a computer-implemented method for protecting an unsecure device coupled to a secure network from an electronic communication containing malware or malicious code. To do this, the cyber secure endpoint device receives a Transmission Control Protocol/Internet Protocol (TCP/IP) communication from a TCP/IP network and performs cybersecurity analysis on the TCP/IP communication to detect the malware or malicious code. When the malware or malicious codes is not detected, a protocol transformation is performed on the TCP/IP communication to create a downstream communication, which is transmitted the downstream communication to the unsecure device via a non-IP addressable communication channel.

In another non-limiting embodiment, the cybersecure endpoint device is utilized in a secure Transmission Control Protocol/Internet Protocol (TCP/IP) communication network to protect an unsecure downstream device coupled to the TCP/IP secure network via the CSE from an electronic communication containing malware or malicious code. Accordingly, the cybersecure endpoint device includes a receiver for receiving a Transmission Control Protocol/Internet Protocol (TCP/IP) communication from the secure TCP/IP network and a data analysis module for performing cybersecurity analysis on the TCP/IP communication to detect the malware or malicious code. When the malware or malicious codes is not detected a communication module performs protocol translation on the TCP/IP communication to create a downstream communication and transmit the downstream communication to the unsecure downstream device via a non-IP addressable communication channel.

### DESCRIPTION OF THE DRAWINGS

Embodiments of the present invention will hereinafter be described in conjunction with the following drawing figures, wherein like numerals denote like elements, and

FIG. 1 is an illustration of the prior TSA system;

FIG. 2 is a chart listing the nine TSA requirements for TSE sensor security;

FIG. 3 is a block diagram illustrating the disclosed embodiments in accordance with one non-limiting implementation;

FIG. 4 is a flow diagram for downstream transmission to TSE sensors following the disclosed embodiments in accordance with one non-limiting implementation; and

FIG. 5 is a flow diagram for upstream transmission from TSE sensors following the disclosed embodiments in accordance with one non-limiting implementation.

### DESCRIPTION OF EXEMPLARY EMBODIMENTS

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims. Furthermore, there is no intention to be bound by any expressed or implied theory presented in the preceding technical field, background or the following detailed description.

The disclosed embodiments relate to a cyber-secure endpoint (CSE) device for use in a TCP/IP system. Following the teachings of the present disclosure, the CSE device permits downstream equipment to be reconnected to secure networks while complying with all of the TSA security requirements or the typical security requirements for any other network used in any particular implementation. According to fundamental embodiments, the CSE device is the endpoint of all TCP/IP communication. Any downstream communication is handled via an encrypted non-IP addressable communication channel. As used herein, “non-IP addressable” means that the device or equipment cannot be addressed by or communicated directly via the TCP/IP protocol. According to the present disclosure, by having the downstream equipment (e.g., TSE sensors) be non-IP addressable the downstream equipment can be reconnected to the TSA (or any) network in a secure manner since the CSE device addresses all cybersecurity matters at the endpoint of TCP/IP communication.

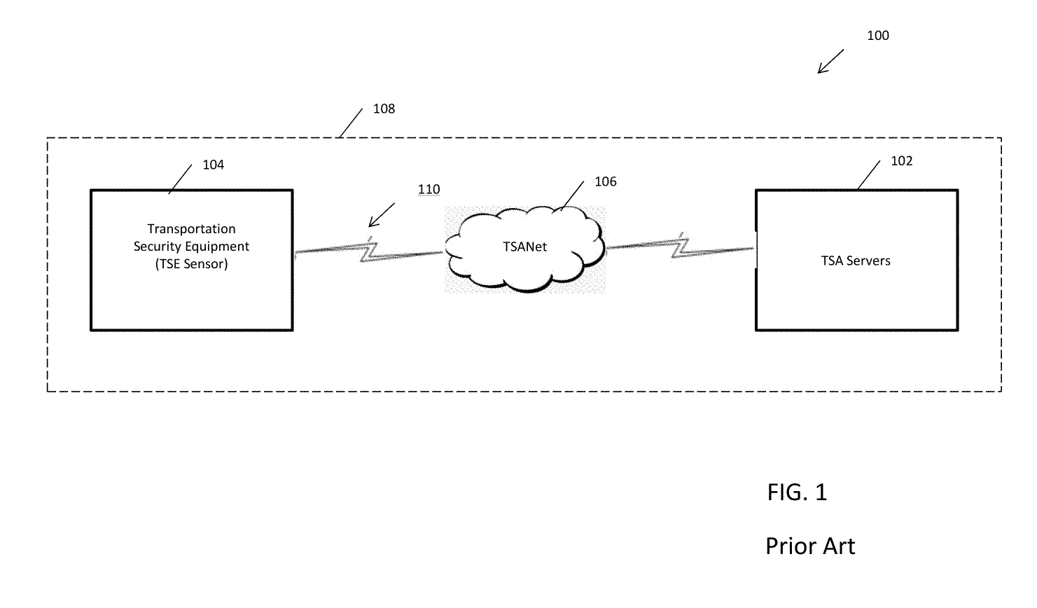

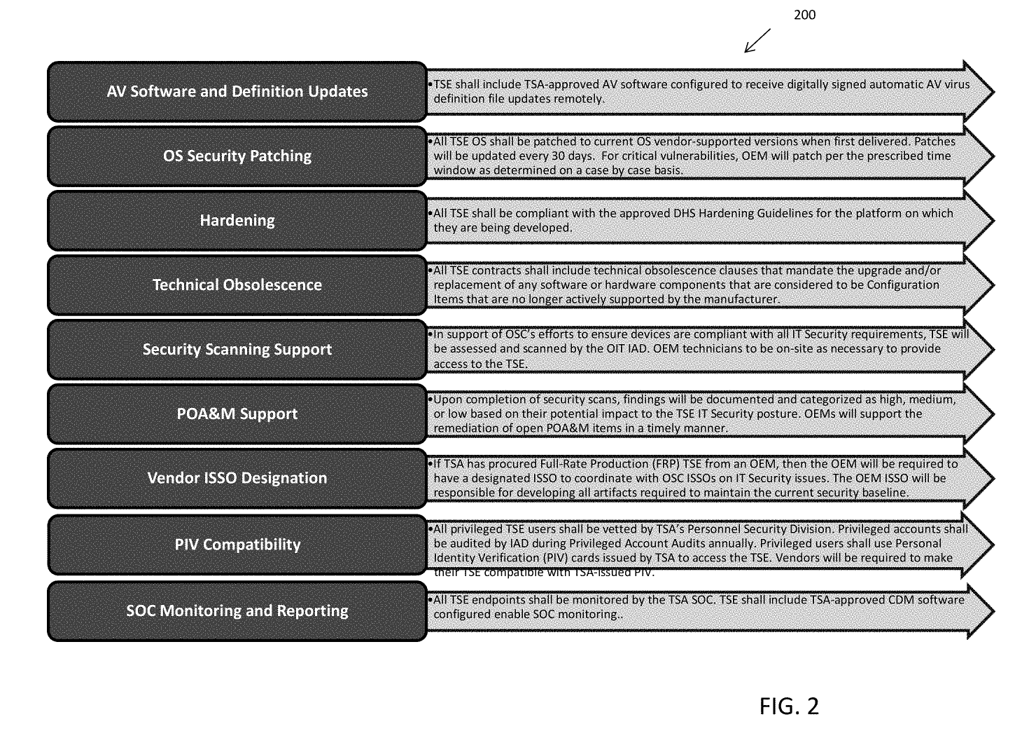

FIG. 1 is an illustration of the prior TSA system 100. In the system 100 the TSA servers 102 were communicatively coupled to the TSE sensors 104 via the TSA network 106. In this manner, the system 100 was IP addressable from end to end as illustrated by the IP addressable network boundary illustrated by 108. Following the DHS OIG audit, the communication path 110 had to be severed resulting in tens of thousands of TSE sensors being disconnected from the network 100. As a result of the audit, the TSA issued the nine requirements 200 set out in FIG. 2 that all TSE equipment must comply with to be coupled to the TSA network 100.

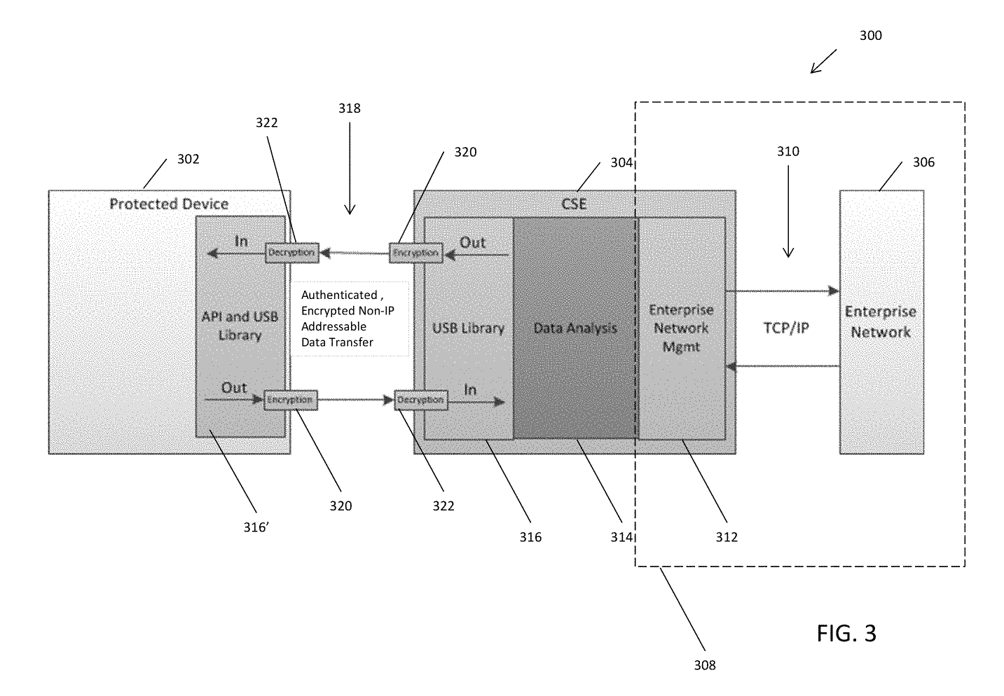

FIG. 3 illustrates a block diagram illustrating the disclosed embodiments of a cyber-secure system 300 in accordance with one non-limiting implementation. According to exemplary embodiments, a protected device 302 (e.g., TSA sensor) can be (re)connected to the system 300 by rendering the protected device 302 non-IP addressable and employing a cyber-secure endpoint device 304 directly in the TCP/IP communication channel between the protected device 302 and the enterprise network 306 (e.g., TSA network). This approach differs from the use of proxy servers in TCP/IP networks in that devices upstream and downstream from the proxy server are both TCP/IP addressable. Accordingly, the TCP/IP addressable boundary of the system 300 is illustrated by 308, which does not include the protected device 302. In a TSA embodiment, since the TCP/IP addressable boundary ends with the cyber-secure endpoint 304, existing TSE sensors can be reconnected in a manner fully compliant with the nine security requirements of the TSA (see FIG. 2).

The CSE device 304 is designed to be fully compliant with all nine security requirements of the TSA. TCP/IP communications 310 are received by the enterprise network management module 312 of the CSE 304. The enterprise network management module 312, provides interfaces for all control and or data components of the system to which the protected device 302 will be connected. Non-limiting examples include field data reporting, device command from the enterprise network 306 and user update lists. Data or information extracted from a communication from the enterprise network 306 are analyzed in the data analysis module 314. The data analysis module 314 analyzes all data passing through the CSE 304 and validates that all data (e.g., images, software updates, queries) are free from unexpected content, malware and are not in furtherance of a cyber attack. In some embodiments, deep packet inspection is utilized as is known in the art. However, it will be appreciated that other cyber-inspection techniques could be used in any particular implementation depending upon the system designer's needs. After the data has been cleared with the data analysis module 314, downstream communications can be sent to the protected device 302 by using a communication module 316. Data communication module 316 of the CSE 304 communicates with a counterpart communications module 316′ residing in the protected device 302. According to non-limiting embodiments, the communication channel 318 is a non-IP communication channel that is directly coupled between the protected (non-IP Addressable) device 302 in the CSE 304. Accordingly, the communication protocol is converted from TCP/IP to whatever protocol is utilized in any particular implementation. Non-limiting examples of such a non-IP communication channel for a non-IP addressable device (302) include universal serial bus (USB), parallel data bus, optical communication channels or other direct connections that promote security via the direct-connect nature of the communication channel. Bi-directional data encryption is provided by encryption modules 320 and decryption is provided by decryption modules 322 within the communication modules 316 and 316′. The encryption may be based upon Public or Private Key Infrastructure as is known in the art, and in some embodiments comprises the Advanced Encryption Standard (AES) method of encryption.

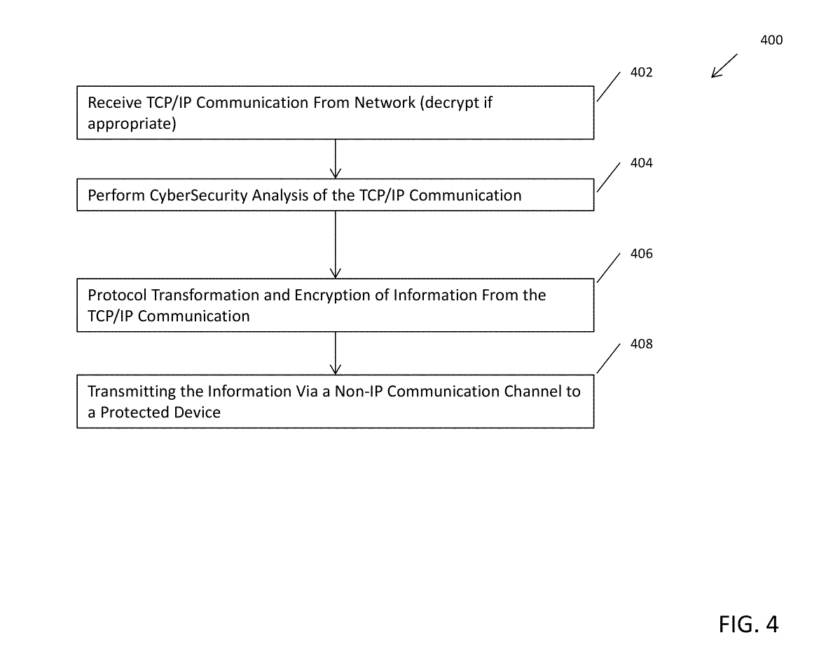

With continued reference to FIG. 3, FIG. 4 is a flow diagram illustrating a method 404 downstream communications. In block 402, the CSE 304 receives a TCP/IP communication from the network 306. If the particular implementation utilizes encrypted communication, decryption of the TCP/IP communication would also be performed. In block 404, the CSE 304 performs cybersecurity analysis (e.g., deep packet inspection) of the TCP/IP communication in the data analysis module 314 of the CSE 304. The downstream communication is encrypted and protocol covered in block 406 using the communication module 316 and the encrypted communication is transmitted via the non-IP communication channel 318 to the non-IP addressable protected device 302.

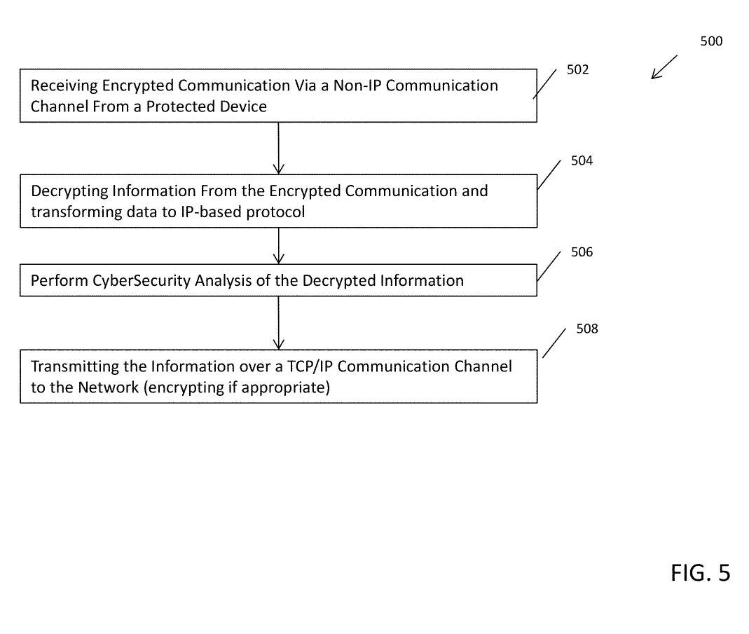

With continued reference to FIG. 3, FIG. 5 illustrates a method 500 for sending data and information upstream from the protected device 302 to the enterprise network 306. In a TSA embodiment, this information may comprise images or data from any of the various TSE sensors, sensor configuration data, or alarms or alerts from the TSE. In block in block 502, the TSE 304 receives an encrypted communication from the communication module 316′ via the non-IP addressable communication channel 318. The information is decrypted and communication protocol converted within the CSE by the communication module 316. The data analysis module performs cybersecurity analysis of the decrypted information from the protected device 302 in block 506. Finally, the CSE transmits the decrypted information over a TCP/IP communication channel 310 to the enterprise network 306 encrypting the communication if used in the TCP/IP communication channel 310.

As described herein, the CSE 304 complies with all nine of the TSA security requirements since the CSE 304:
incorporates all TSA-approved AV software to receive the latest signature updates from TSA Enterprise.
The operating system is vendor supported and patches will be installed in accordance with the appropriate timelines given the criticality of the update.
The is compliant with the DHS hardening guidelines for its operating system.
The has a technical obsolescence support plan.
The available for scanning and certification by TSA's Office of Information Technology (OIT) Information Assurance Division (IAD).
The support team will resolve POA&Ms from the security scanning in the appropriate time.
The has an ISSO identified.
The supports PIV user validation.
The has software that enables the TSA SOC to monitor the device.

Those of skill in the art would appreciate that the various illustrative components, members and modules described in connection with the embodiments disclosed herein may be implemented in various configurations. Particularly, it will be appreciated by those skilled in the art that the CSE 304 of the present disclosure is not limited to a TSA application, or any particular application, and may allow equipment that is non-secure by any definition to be connected to a secure network. Moreover, it will be understood that the CSE 304 can be readily incorporated into new equipment permitting the new equipment to be connected to a TCP/IP addressable network without further modification to existing equipment rather than redesigning TSE sensors to comply with the nine TSA security requirements. It will be understood that skilled artisans may implement the described functionality in varying ways for each particular application, but such implementation decisions should not be interpreted as causing a departure from the scope of the present disclosure. In addition, those skilled in the art will appreciate that embodiments described herein are merely exemplary implementations.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text does not imply that process steps must be performed in a temporal or logical order according to such sequence unless it is specifically defined by the language of the claim. The process steps may be interchanged in any order without departing from the scope of the invention as long as such an interchange does not contradict the disclosed teachings and is not logically nonsensical.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth herein.

What is claimed is:

1. A computer-implemented method for protecting an unsecure device coupled to a secure network from an electronic communication containing malware or malicious code, comprising, executing on a processor at a cyber secure endpoint device, the steps of:
receiving a Transmission Control Protocol/Internet Protocol (TCP/IP) communication from a TCP/IP network;
performing cybersecurity analysis on the TCP/IP communication to detect the malware or malicious code; and
when the malware or malicious codes is not detected, perform a protocol transformation from the TCP/IP communication to create a downstream communication, and transmit the downstream communication to the unsecure device via a non-IP addressable communication channel.

2. The computer-implemented method of claim 1, which includes the step of encrypting the downstream communication prior to transmitting the downstream communication to the unsecure device via the non-IP addressable communication channel.

3. The computer-implemented method of claim 2, wherein the step of transmitting the downstream communication to the unsecure device via the non-IP addressable communication channel comprises transmitting the downstream communication to the unsecure device via universal serial bus (USB) communication channel.

4. The computer-implemented method of claim 1, wherein the step of cybersecurity analysis includes the step of performing deep packet inspection of the TCP/IP communication.

5. The computer-implemented method of claim 1, further comprising the steps of:
receiving a communication from the unsecure device via the non-IP addressable communication channel;
performing cybersecurity analysis on the TCP/IP communication to detect the malware or malicious code; and
when the malware or malicious codes is not detected, perform a protocol transformation to create an upstream communication, and transmitting the upstream communication via a Transmission Control Protocol/Internet Protocol (TCP/IP) communication channel to a TCP/IP network.

6. The computer-implemented method of claim 1, further comprising the step of encrypting the upstream communication prior to transmission via the TCP/IP communication channel to the TCP/IP network.

7. A cybersecure endpoint (CSE) device for use in a secure Transmission Control Protocol/Internet Protocol (TCP/IP) communication network to protect a unsecure downstream device coupled to the TCP/IP secure network via the CSE from an electronic communication containing malware or malicious code, comprising:
a receiver for receiving a Transmission Control Protocol/Internet Protocol (TCP/IP) communication from the secure TCP/IP network;
a data analysis module for performing cybersecurity analysis on the TCP/IP communication to detect the malware or malicious code; and
a communication module configured to perform protocol translation on the TCP/IP communication when the malware or malicious codes is not detected to create a downstream communication and transmit the downstream communication to the unsecure downstream device via a non-IP addressable communication channel.

8. The cybersecure endpoint (CSE) device of claim 7, wherein the communication module includes an encryption module for encrypting the downstream communication prior to transmitting the downstream communication to the unsecure downstream device via the non-IP addressable communication channel.

9. The cybersecure endpoint (CSE) device of claim 7, wherein the communication module transforms the TCP/IP communication into a downstream communication compatible with a universal serial bus (USB) communication channel.

10. The cybersecure endpoint (CSE) device of claim 7, wherein the data analysis module is configured to perform deep packet inspection of the TCP/IP communication.

11. The cybersecure endpoint (CSE) device of claim 7, further comprising:
a receiver for receiving a communication from the unsecure downstream device via the non-IP addressable communication channel;
the communication module being further configured to perform a protocol transformation to create an upstream communication, and the data analysis module being further configured to perform cybersecurity analysis on the upstream communication to detect the malware or malicious code
a transmitter for transmitting the upstream communication via a Transmission Control Protocol/Internet Protocol (TCP/IP) communication channel to a secure TCP/IP network when the malware or malicious codes is not detected.

12. The cybersecure endpoint (CSE) device of claim 7, wherein the communications module further comprises an encryption module for encrypting the upstream communication prior to transmitting via the TCP/IP communication channel to the secure TCP/IP network.

13. The cybersecure endpoint (CSE) device of claim 7, wherein the unsecure downstream device comprises a Transportation Security Agency (TSA) sensor.

14. In a communication system having secure devices utilizing Transmission Control Protocol/Internet Protocol (TCP/IP) communication channels and unsecure devices utilizing non-IP addressable communication channels, one or more cybersecure endpoint (CSE) devices positioned in the communication system between the secure devices and the unsecure devices to protect the unsecure devices from an electronic communication containing malware or malicious code, comprising:
a transceiver for communicating via the Transmission Control Protocol/Internet Protocol (TCP/IP) communication channels with the secure devices of the communication system;
a transceiver for communicating via the non-IP addressable communication channels with the unsecure devices of the communication system;
a data analysis module for performing cybersecurity analysis on information received via the TCP/IP communication channels and the non-IP addressable channels to detect the malware or malicious code; and
a communication module configured to perform protocol translation on the information to provide communication between the TCP/IP communication channels and the non-IP addressable channels TCP/IP communication channels when the malware or malicious codes is not detected.

15. The cybersecure endpoint (CSE) device of claim 14, wherein the communication module includes a bi-directional encryption module for encrypting and decrypting information between the TCP/IP communication channels and the non-IP addressable channels TCP/IP communication channels.

16. The cybersecure endpoint (CSE) device of claim 14, wherein the non-IP communication channels comprise universal serial bus (USB) communication channels.

17. The cybersecure endpoint (CSE) device of claim 14, wherein the data analysis module is configured to perform deep packet inspection of the communications between the TCP/IP communication channels and the non-IP addressable channels TCP/IP communication channels.

18. The cybersecure endpoint (CSE) device of claim 14, wherein the unsecure devices comprises Transportation Security Agency (TSA) sensors.
